(19) United States
(12) Patent Application Publication
(10) Pub. No.: US 2014/0036487 A1
(43) Pub. Date: Feb. 6, 2014

(54) Anchor device for securing blankets to the ground

(71) Applicant: Dawn E. Adams, Brooklyn, NY (US)

(72) Inventor: Dawn E. Adams, Brooklyn, NY (US)

(21) Appl. No.: 13/564,487

(22) Filed: Aug. 1, 2012

(51) Int. Cl. F16B 1/00; B65D 25/00; F21L 4/02; F16B 2/20; F21L 4/00

(52) U.S. Cl. 362/184; 24/72.5; 362/190; 220/737

(57) ABSTRACT

A device for anchoring an object to a surface includes an elongated shaft having opposed distal and proximal end portions and a surface engagement member operatively associated with the distal end portion of the elongated shaft. The surface engagement member is adapted and configured for radial engagement with the surface. The device further includes an object engagement member operatively associated with the proximal end portion of the elongated shaft whereby the object engagement member adapted and configured for releasably engaging the object.

### BACKGROUND

1. Technical Field

The present invention generally relates devices that anchor or secure objects to the ground, and more particularly, to a blanket anchor.

2. Description of Related Art

Various items are brought to an outing such as a picnic or a beach can include for example, towels, blankets, table cloths, place setting items, etc. Some of these items are often subject to various weather conditions such as wind and the comings and going of people (e.g., people ruffling blankets). Although conventional anchors have been made to date, such anchors have not proven satisfactory at securing items to a surface (e.g., the ground). Accordingly, despite efforts to date, improvements are needed for improved devices for securing objects to surfaces.

### SUMMARY

The invention generally relates to improved anchor devices that fix an object to a surface. The improved devices provide for a durable and secure fixture.

In accordance with one aspect of the disclosure, a device for anchoring an object to a surface includes an elongated shaft having opposed distal and proximal end portions, a surface engagement member operatively associated with the distal end portion of the elongated shaft and an object engagement member operatively associated with the proximal end portion of the elongated shaft. The surface engagement member can be adapted and configured for rotationally engaging the surface (e.g., an auger design), and the object engagement member can be adapted and configured for releasably engaging the object. Notably, the object engagement member includes a top surface having a surface area, which can be adapted for receiving a logo, and the elongated shaft can be tapered from the proximal end portion to the distal end portion.

In addition, in certain embodiments, the object engagement member is releasably attached to the proximal end portion of the elongated shaft. For example both the object engagement member and the proximal end portion of the elongated shaft can have complimentary threaded patterns.

In other embodiments, the object engagement member can for example, include a spring-loaded clamp having teeth that releasably attach to the object. Alternatively, or in addition thereto, the object engagement member can include an energy source (e.g., a solar cell) and an illumination source (e.g., a light emitting diode (LED)) powered by the energy source.

In additional embodiments, the engagement member can include a first mechanism adapted and configured for releasably engaging the object (i.e., a first object), and a second mechanism adapted and configured for releasably engaging a second object.

In certain other embodiments, the elongated shaft can include at least one recess extending along a length of the elongated shaft. Alternatively, or in addition thereto, the elongated shaft can include at least one cavity. The cavity or cavities can extend along a length of the elongated shaft.

Still further, in some embodiments, the object engagement member can be adapted and configured to receive a beverage.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a first representative embodiment of an anchor device accordance with the present disclosure, showing the device securing an object to a surface;

FIG. 2 is a perspective view of the anchor device of FIG. 1;

FIG. 3 is a left-side view of the anchor device of FIG. 1;

FIG. 4 is a right-side view of the anchor device of FIG. 1;

FIG. 5 is a back-end view of the anchor device of FIG. 1;

FIG. 6 is a front-end view of the anchor device of FIG. 1;

FIG. 7 is a top-end view of the anchor device of FIG. 1;

FIG. 8 is a bottom-end view of the anchor device of FIG. 1;

FIG. 9 is an exploded-perspective view of the anchor device of FIG. 1;

FIG. 10 is a perspective view of another embodiment of an anchor device for securing an object to a surface, showing a recess in an elongated shaft of the device;

FIG. 11 is a perspective view of the anchor device of FIG. 10, viewed from an underside of an object engagement member, showing an etched seam along the underside of the object engagement member; and

FIG. 12 is an exploded-perspective view of another embodiment of an anchor device for securing an object to a surface, showing a receptacle configured to attach to an elongated shaft of the anchor device.

### DESCRIPTION

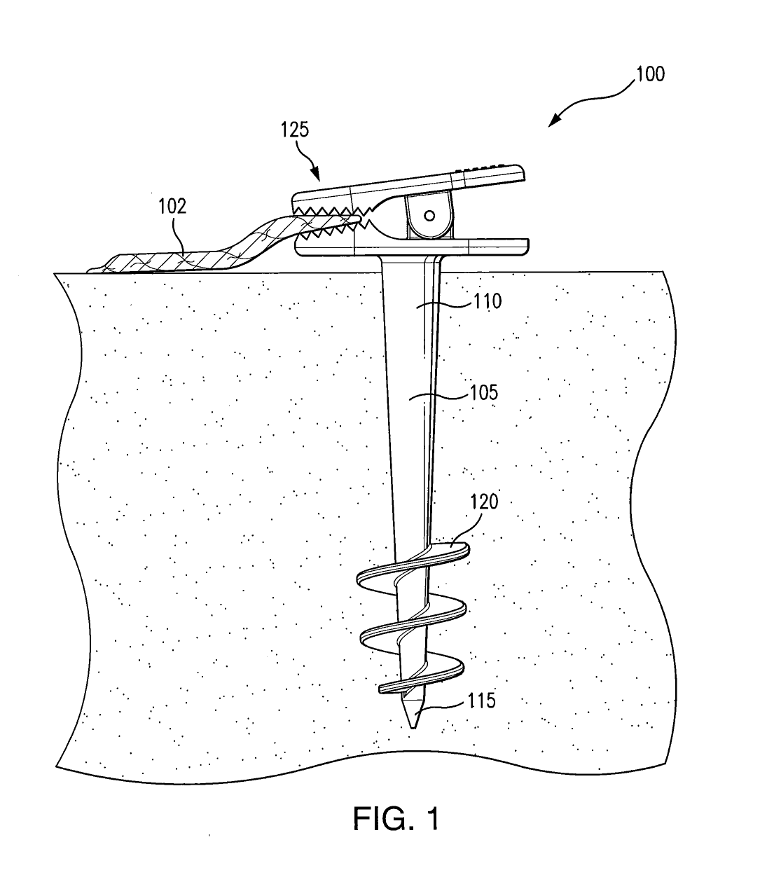

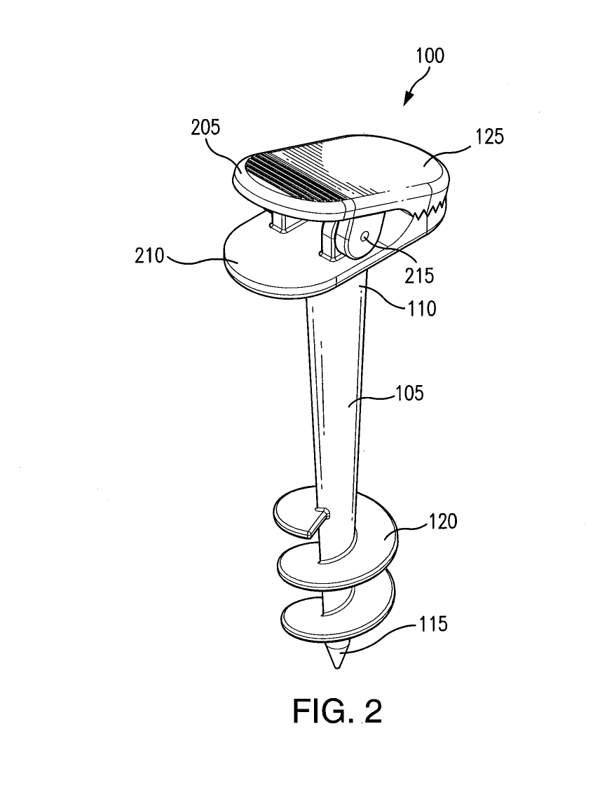

Reference will now be made to the drawings wherein like reference numerals identify similar structural features or aspects of the subject invention. For purposes of explanation and illustration, and not limitation, one embodiment of an anchor device accordance with the present disclosure, showing the device securing an object to a surface view of an exemplary is shown in FIG. 1 and is designated generally by reference character 100. Other views and various other embodiments of devices for securing objects to surfaces in accordance with the invention, or aspects thereof, are provided in FIGS. 2-12, as will be described herein. The devices of the present disclosure can be used for various environments (e.g., sand, soil, gravel, etc.) and for securing a variety of objects (e.g., towels, blankets, towels, sarongs, etc.).

As shown in FIG. 1, an anchor device 100 is illustrated. Anchor device 100, as shown, secures a blanket 102 to a ground surface. Anchor device 100 includes an elongated shaft 105 having a distal end portion 115 and a proximal end portion 110. Anchor device 100 further includes a surface engagement member 120 operatively associated with the distal end portion 115. Notably, surface engagement member 120 is adapted and configured for radial engagement with the ground surface. That is, surface engagement member 120, as shown, is formed into an auger mechanism to drill into the ground surface. Further, although distal end portion 115 is illustrated as tapered to a point, in some embodiments, distal end portion can be rounded (e.g., a nub at the end).

With respect to engagement of the towel, anchor device 100 includes an object engagement member 125 which is adapted and configured for releasably engaging the object (i.e., the towel). As shown, object engagement member 125 can be a spring-loaded clamp mechanism that opens and closes. As discussed in greater detail below, object engagement member 125 can be constructed as single piece with elongated shaft 105 or as a separate piece, which can be joined or connected to shaft 105.

Referring now to FIG. 2, a perspective view of the anchor device of FIG. 1 is illustrated. As discussed above, anchor device 100 includes a shaft 105, which, as illustrated, can be tapered from proximal end portion 110 to distal end portion 115 to form a point. In addition, as shown in FIG. 2, object engagement member 125 includes a clamp-like mechanism having a top portion 205 and a bottom portion 210. Top portion 205 and bottom portion 210 hinge about hinge 215 to open and close the object engagement member 125.

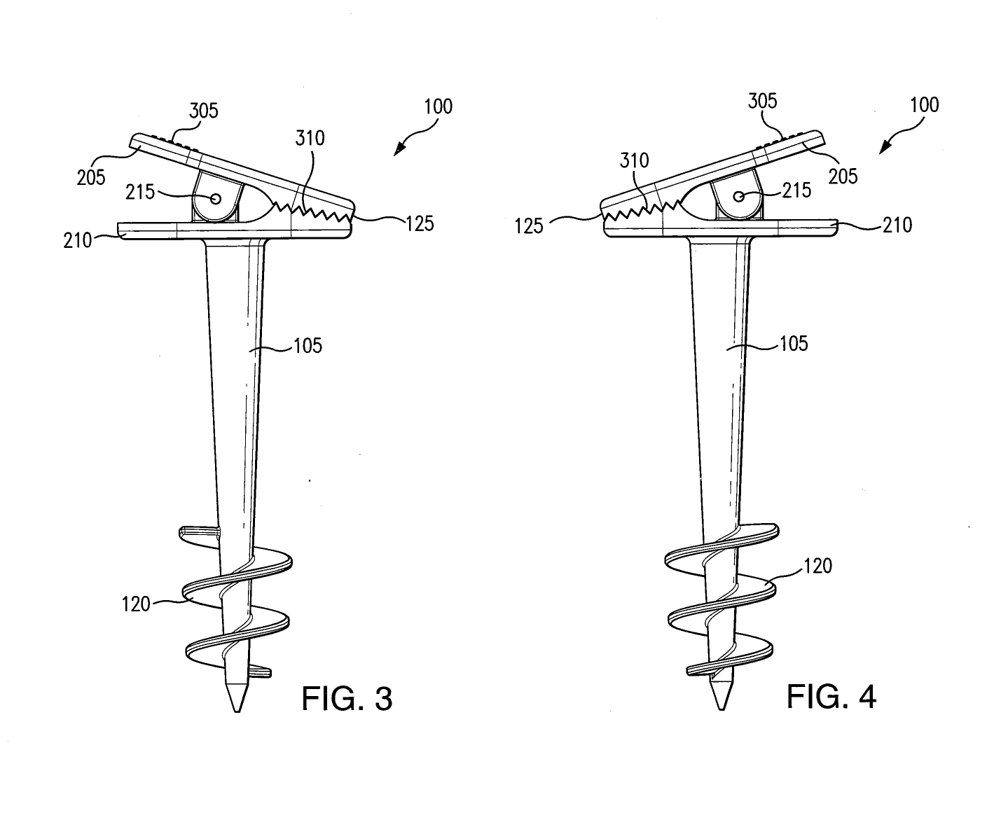

Referring now to FIGS. 3-4, a left-side view and a right-side view of the anchor device 100 of FIG. 1 are illustrated, respectively. Notably, anchor device 100 also includes raised structures 305, which provides a gripping surface for a user (not shown) to press upon, thereby opening and closing object engagement member 125. Further, as discussed above, object engagement member 125 can include a spring-loaded clamp design having jagged, non-linear “teeth” 310, which can releasably attach to the object facilitate securing the object to anchor device 100.

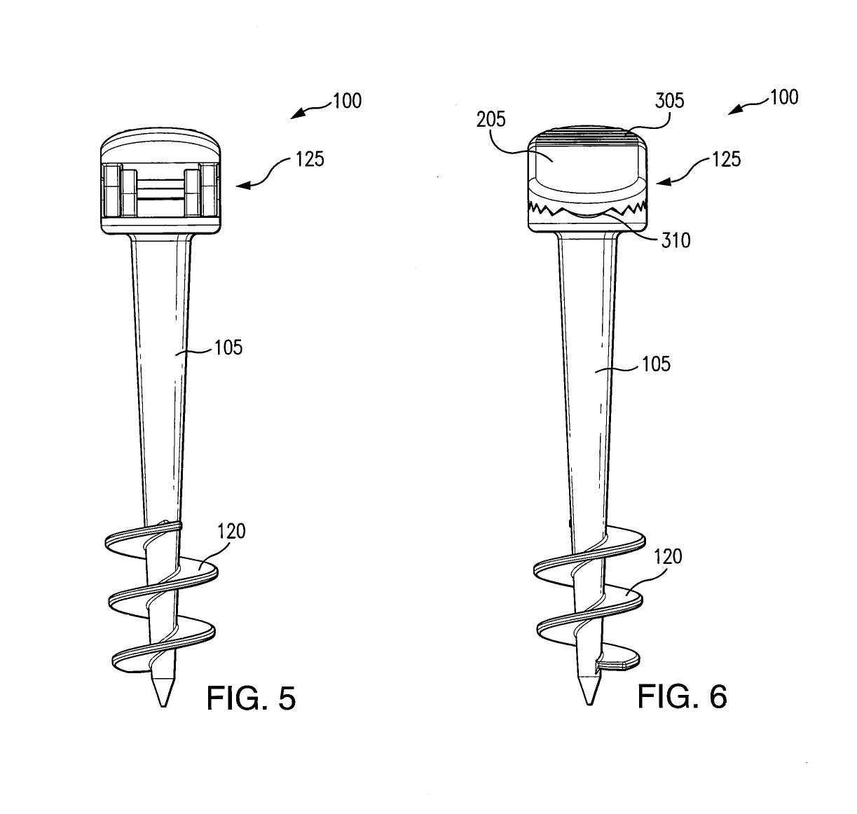

Referring now to FIGS. 5-6, a back-end view and a front-end view of the anchor device 100 is illustrated, respectively. Notably, with particular reference to FIG. 6, top portion 205 of object engagement member 125 includes a surface area adapted to receive a logo.

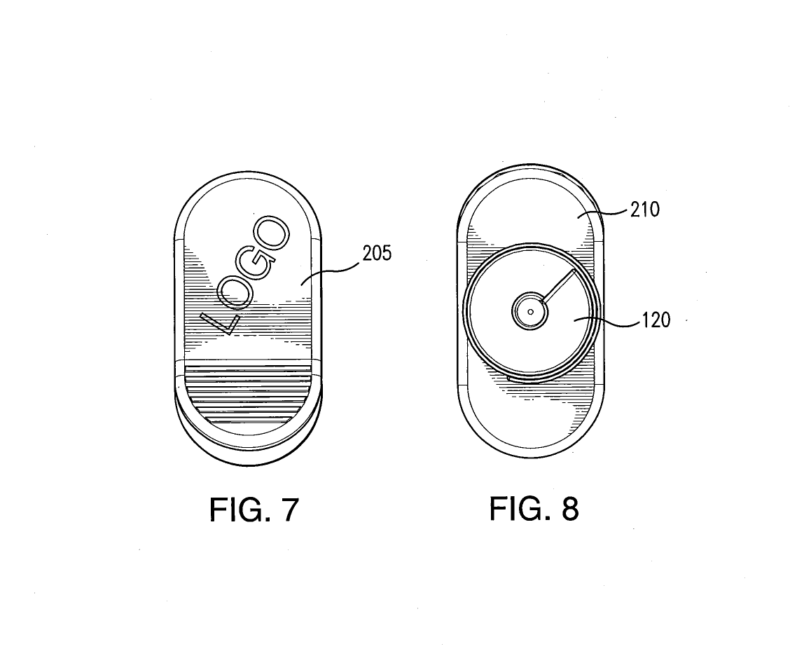

Referring now to FIGS. 7-8, a top-end view and a bottom-end view of anchor device 100 is illustrated, respectively. As discussed above with reference to FIG. 6, FIG. 7 highlights top end portion 205 having a surface area adapted to receive a logo. In further embodiments, anchor device 100 can include an energy source such as, but not limited to: a battery, solar cells, etc. Moreover, in these embodiments, object engagement member 125 (and particularly, top-end portion 205) can include an illumination source (e.g., a light emitting diode (LED)) powered by the energy source. Accordingly, these embodiments allow anchor device 100 to provide a source of light.

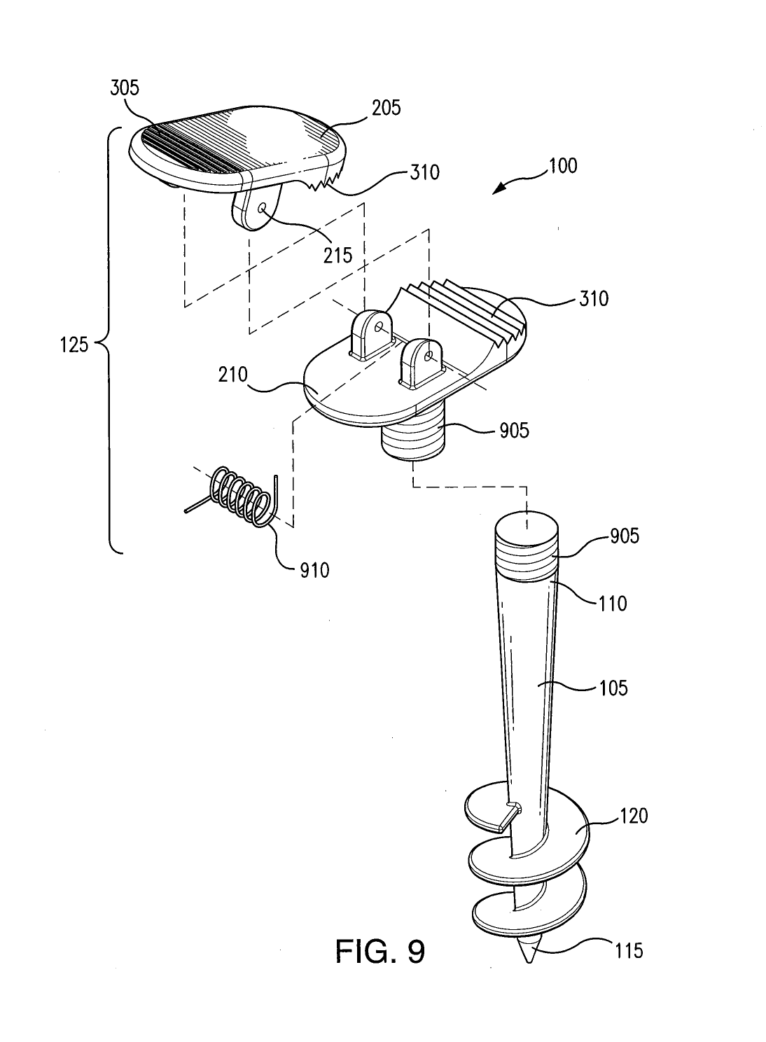

Referring now to FIG. 9, an exploded-perspective view of the anchor device 100 is illustrated. As discussed above, object engagement member 125 can include a top end 205 and a bottom end 210, connected via a hinge. The hinge can also include a spring 910 that biases object engagement member 125 in a closed position. As shown, object engagement member 125 can further releasably attach to proximal end portion 110 of shaft 105. For example, as illustrated, object engagement member 125 and proximal end portion 110 of the shaft can include complementary threading 905. As appreciated by those skilled in the art, various other suitable means of releasably securing object engagement member 125 to shaft 105 can be used (e.g., a snap closure, etc.). Further, in some embodiments, as is appreciated by those skilled in the art, shaft 1005 may be include a hallow design.

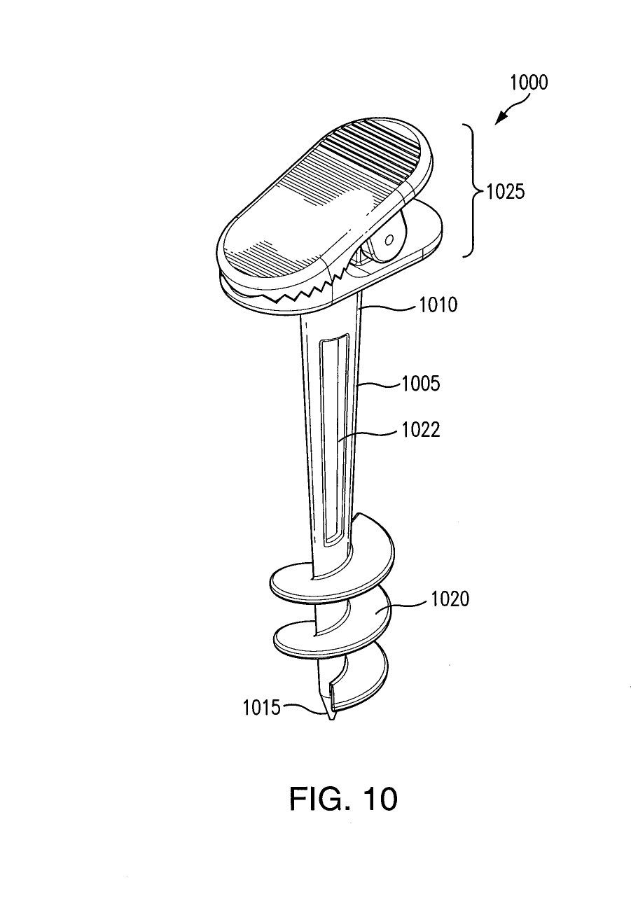

Referring now to FIG. 10, a perspective view of another embodiment of an anchor device 1000 for securing an object to a surface is shown. In particular, FIG. 10, similar to FIG. 1, includes an elongated shaft 1005 having a proximal end portion 110 and a distal end portion 1015. Anchor device 1000 also includes an object engagement member 1025 operatively associated with proximal end portion 1010 and a surface engagement member operatively associated with distal end portion 1015. The surface engagement member is adapted and configured for radial engagement with a surface (not shown).

Importantly, anchor device 1000 further includes a recess 1022 that extends along a length of shaft 1005. Recess 1022 reduces the amount of material used in manufacture of anchor device 1000 and, further, provides for a larger surface area for the ground to contact. That is, once anchor device is engaged with the ground (e.g., via radial engagement or being screwed into the ground), the ground material will contact and fill in around anchor device 1000. Recess 1022 allows for a larger amount of ground material to contact with anchor device 1000 thereby providing a more secure engagement. Further, in some embodiments, recess 1022 can be a cavity formed through shaft 1005. The cavity, like recess 1022 can extend along a length of shaft 1005.

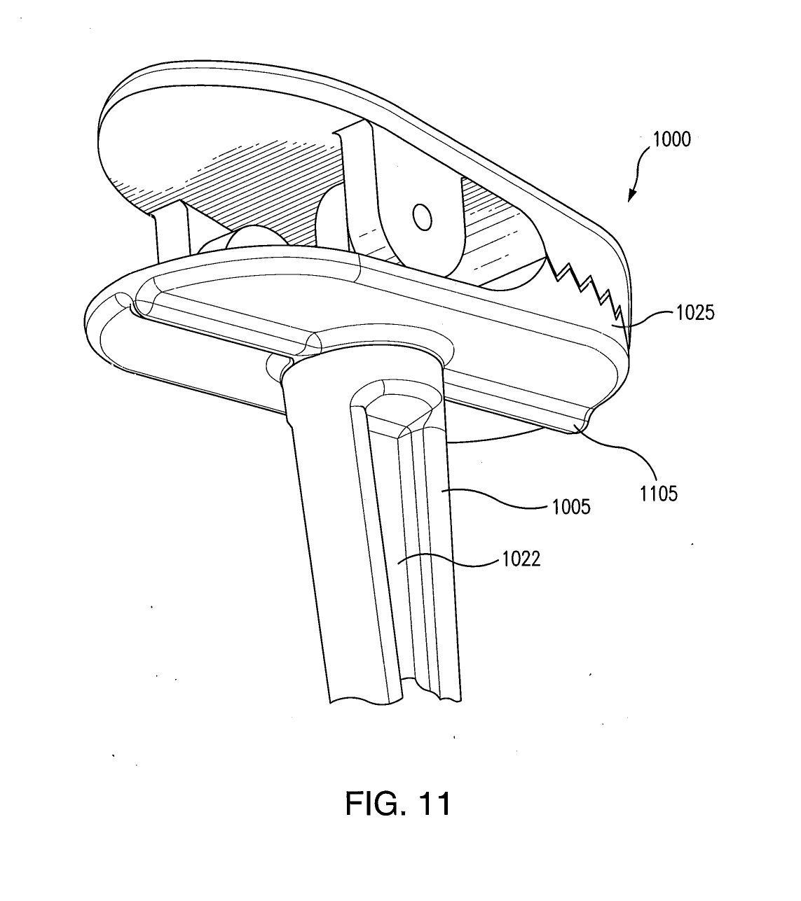

Referring now to FIG. 11, another perspective view of the anchor device 1000 is shown. Notably, FIG. 11 is a perspective view from an underside angle of anchor device 1000. As shown, object engagement member 1025 includes a seam 1105 etched along an underside. Notably, this etched seam highlights a minimal manufacturing technique so as to minimize the material required to manufacture anchor device 1000.

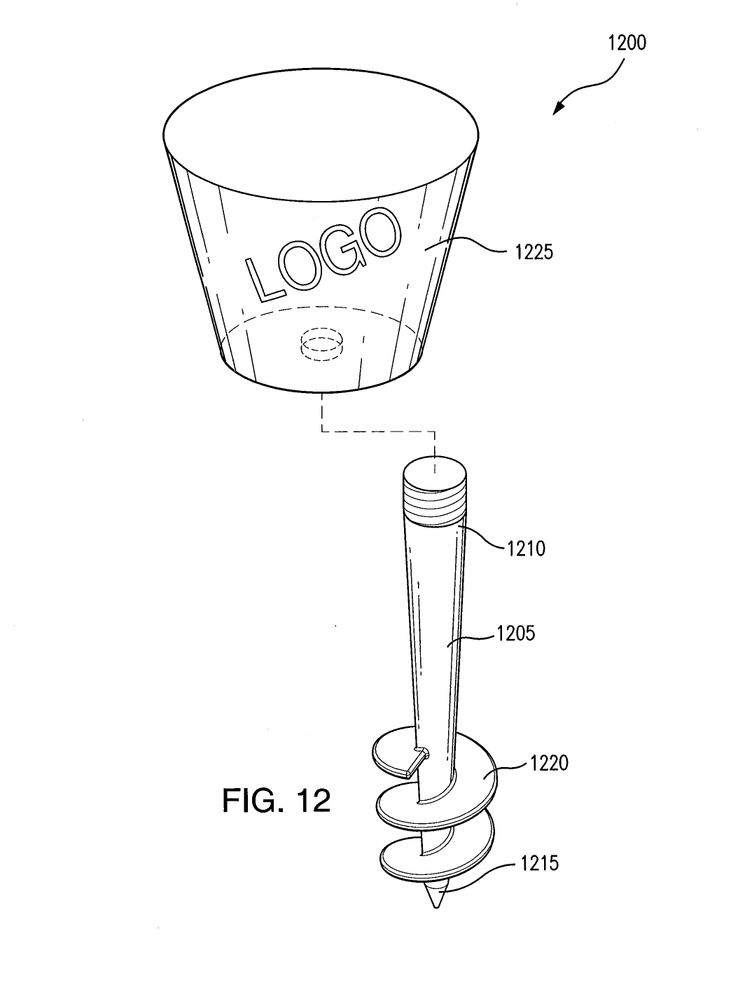

FIG. 12 is an exploded-perspective view of another embodiment of an anchor device 1200 for securing an object to a surface, showing a receptacle 1225 configured to attach to an elongated central shaft 1205 of the anchor device. Anchor device 1200, as illustrated includes an elongated shaft 1205 having a distal end portion 1210 and a proximal end portion 1215. Anchor device 1200 further includes a surface engagement member operatively associate with distal end portion 1215, and is adapted and configured for radial engagement with a surface (not shown). Moreover, in this embodiment, anchor device 1200 includes a cup-shaped receptacle configured to receive, for example, a beverage, food items, etc. Receptacle 1225 is should not be considered limited to a cup-shaped design, but, rather, as appreciated by those skilled in the art, receptacle 1225 can include various other design configurations to receive miscellaneous items form the user.

Notably, receptacle 1225 attaches to a proximal end portion 1210 of elongated shaft 1205 via various means of attachment. As shown, receptacle 1225 and proximal end portion 1210 can be configured to slidably communicate so as to attach receptacle 1225 to proximal end portion 1210 of elongated shaft 1205. Alternatively, as discussed above, receptacle 1225 and proximal end portion 1210 can also include complimentary threading so as to screw together.

While there have been shown and described illustrative embodiments that provide for devices for securing objects to a surface, it is to be understood that various other adaptations and modifications may be made within the spirit and scope of the embodiments herein. For example, while embodiments of the object engagement member are discussed with separate figures, it is expressly contemplated that mixing, matching, and combining various types of object engagement members with the various elongated shafts is possible. For example, the object engagement member of FIG. 1 can be interchangeable with the object engagement member of FIG. 12. Also, while the devices and techniques generally describe securing an object such as a blanket to a surface such as beach, the devices and techniques can be adapted for any type of surface (e.g., soil, grass, etc.) and securing various other types of objects thereto (e.g., dog leashes, jackets, towels, etc.) without departing from the spirit and scope of this disclosure.

The foregoing description has been directed to specific embodiments. It will be apparent, however, that other variations and modifications may be made to the described embodiments, with the attainment of some or all of their advantages. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A device for anchoring an object to a surface, comprising:
a) an elongated shaft having opposed distal and proximal end portions;
b) a surface engagement member operatively associated with the distal end portion of the elongated shaft, the surface engagement member adapted and configured for rotationally engaging the surface; and
c) an object engagement member operatively associated with the proximal end portion of the elongated shaft, the object engagement member adapted and configured for releasably engaging the object.

2. A device as recited in claim 1, wherein the object engagement member is releasably attached to the proximal end portion of the elongated shaft.

3. A device as recited in claim 2, wherein the proximal end portion of the elongated shaft has a threaded pattern, wherein the object engagement member is releasably attached to the proximal end portion of the elongated shaft via a complementary threaded pattern.

4. A device as recited in claim 2, wherein the object engagement member comprises:
a spring-loaded clamp having teeth that releasably attach to the object.

5. A device as recited in claim 1, further comprising:
an energy source, and
an illumination source powered by the energy source, the illumination source operatively in communication with the object engagement member.

6. A device as recited in claim 5, wherein the energy source comprises at least a solar cell and the illumination source comprises at least one light emitting diode (LED).

7. A device as recited in claim 2, wherein the object is a first object, wherein the object engagement member has a first mechanism adapted and configured for releasably engaging the first object and a second mechanism adapted and configured for releasably engaging a second object.

8. A device as recited in claim 2, wherein the object engagement member has a top surface having a surface area adapted for receiving a logo.

9. A device as recited in claim 2, wherein the elongated shaft further includes at least one recess extending along a length of the elongated shaft.

10. A device as recited in claim 2, wherein the elongated shaft further includes at least one cavity that extends along a length of the elongated shaft.

11. A device as recited in claim 10, wherein the elongated shaft is tapered from the proximal end portion to the distal end portion.

12. A device as recited in claim 2, wherein the object engagement member is adapted and configured to receive a beverage.

13. A device as recited in claim 1, wherein the surface engagement member adapted and configured for rotationally engaging the surface is an auger.

14. A device as recited in claim 1, wherein the elongated shaft is hallow in design.
